(19) United States
(12) Patent Application Publication
(10) Pub. No.: US 2026/0277779 A1
(43) Pub. Date: Sep. 17, 2026

(54) ALLOCATING RESOURCES IN A MICROSERVICE SYSTEM

(71) Applicant: SAP SE, Walldorf (DE)

(72) Inventor: Hui Li, Shanghai (CN)

(21) Appl. No.: 19/077,432

(22) Filed: Mar. 12, 2025

(51) Int. Cl. G06F 11/3668; G06F 11/34

(52) U.S. Cl. CPC G06F 11/3692; G06F 11/3447; G06F 11/3688

(57) ABSTRACT

Systems and methods disclosed herein deploy microservices to a test system, simulate a production environment, and test the microservices to gather data about the actual relative resource consumption and capacities of the microservices. Using the gathered data, a resource allocation to be used for the microservices is determined. The production environment is configured according to the determined resource allocation. An administrator may manually adjust the determined resource allocations.

### TECHNICAL FIELD

The subject matter disclosed herein generally relates to systems for allocating resources in a microservice system.

### BACKGROUND

More and more software systems are adopting microservices architecture, composed of many independently small services. These small services often communicate with each other by remote call, such as hypertext transport protocol (HTTP), Google Remote Procedure Calls (gRPC), or Thrift. The capacity of the service is limited by many factors, and the central processing unit (CPU) and memory can be the most influential or important resources for every service as they relate to each services' capacity to execute tasks.

Usually, different services are developed by different teams. Each team estimates the resources that will be needed by their service to process service calls at a certain rate. To avoid being blamed for problems in the software system, teams tend to request more CPU and memory resources for their services than are actually needed.

### BRIEF DESCRIPTION OF THE DRAWINGS

FIG. 1 shows a network diagram illustrating an example network environment suitable for allocating resources in a microservice system.

FIG. 2 shows a block diagram of an application server, suitable for allocating resources in a microservice system.

FIG. 3 is a block diagram of an example microservice system comprising six microservices, with an initial allocation of resources.

FIG. 4 is a block diagram of the example microservice system, after allocation of resources.

FIG. 5 shows an illustration of an example user interface for allocating resources in a microservice system.

FIG. 6 shows an illustration of an example user interface for allocating resources in a microservice system.

FIG. 7 shows a flowchart illustrating a method of allocating resources in a microservice system.

FIG. 8 shows a block diagram showing one example of a software architecture for a computing device.

FIG. 9 shows a block diagram of a machine in the example form of a computer system within which instructions may be executed for causing the machine to perform any one or more of the methodologies discussed herein.

### DETAILED DESCRIPTION

Example methods and systems are directed to allocating resources in a microservice system. In a microservices application, independent small services provide specific functions. The small services communicate with each other using remote call protocols such as HTTP or gRPC.

Resources for the microservices may be allocated according to resource consumption and capacity estimates provided by the developers of each microservice. However, the estimates may be inaccurate, either due to deliberate over-engineering or due to mistake. Since microservices can depend on each other, over-allocation of resources to a first microservice and under-allocation of resources to a second microservice used by the first microservice may cause worse performance of the first microservice. Paradoxically, in such a situation, reducing resources allocated to the first microservice (and allocating them to the second microservice) improves the performance of the first microservice.

Systems and methods disclosed herein deploy microservices to a test system, simulate a production environment, and test the microservices to gather data about the actual relative resource consumption and capacities of the microservices. The gathered data is used to determine a resource allocation for the microservices. The production environment is configured according to the determined resource allocation. An administrator may manually adjust the determined resource allocations.

As discussed herein, systems and methods for quantitatively determining the allocation of resources in a microservice system are provided. By use of the described systems and methods, the efficient allocation of resources in a microservice system is facilitated. By comparison with systems that do not use quantitative analysis, the efficiency of the resulting microservices system is improved. The improved efficiency derives from balancing the allocation of resources among the microservices according to their relative consumption rather than based on guesswork. As a result, the functioning of the microservice system itself is improved.

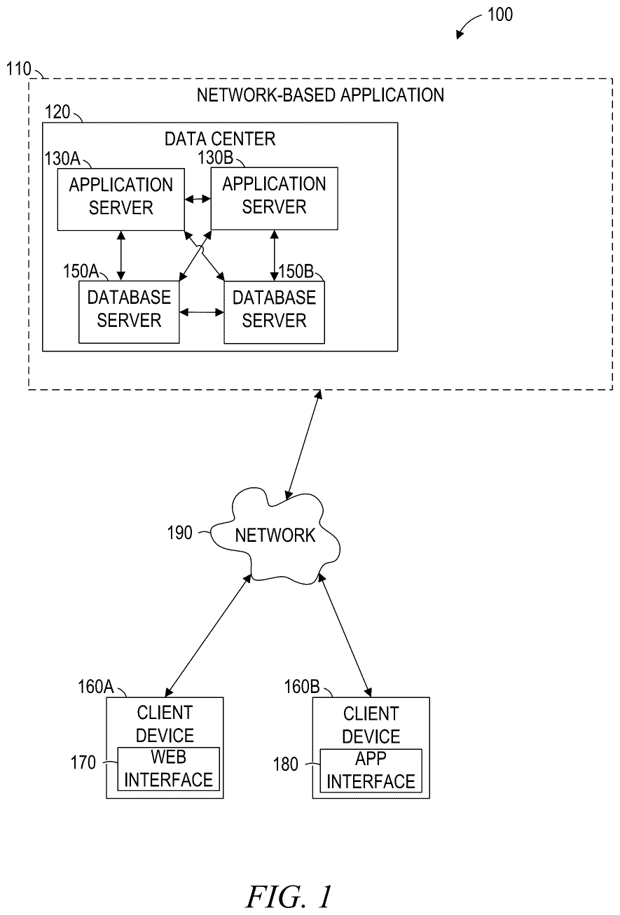

FIG. 1 shows a network diagram illustrating an example network environment 100 suitable for allocating resources in a microservice system. The network environment 100 includes a network-based application 110, client devices 160A and 160B, and a network 190. The network-based application 110 is implemented at a data center 120 comprising application servers 130A and 130B in communication with database servers 150A and 150B. An application executing on the application servers 130A-130B may access data from the database servers 150A-150B. The letter suffixes of reference numbers may be omitted when doing so does not raise ambiguity. For example, the application servers 130A-130B may be referred to collectively as “application servers 130.” Similarly, when the specific one of the application servers 130A-130B is not of particular import, “application server 130” may be referenced.

The application running on the application server 130 may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface for the application may be presented using a web interface 170 or an app interface 180.

The network-based application 110 may be implemented as a monolithic application using a layered architecture or by using a collection of microservices. One or more of the application servers 130 may act as a registration server. Microservices register themselves with the registration server. Once a microservice is registered, it can be discovered by requests to the registration server. For example, a user of the client device 160A may request information about a microservice by providing the name of the microservice or a description of the microservice to the registration server. In response, the registration server provides information about one or more registered microservices. The user may use the provided information to configure the network-based application 110 to make use of one or more of the microservices.

The application servers 130 may communicate with the database servers 150 using a representational state transfer (REST) application programming interface (API), the Open Data Protocol (ODATA), or another API. The data may be described in metadata that provides contextual information related to the data. Metadata includes column names, data types and data relationships. If the values are from a fixed dataset, the dataset may be loaded and the loaded information used as a table description.

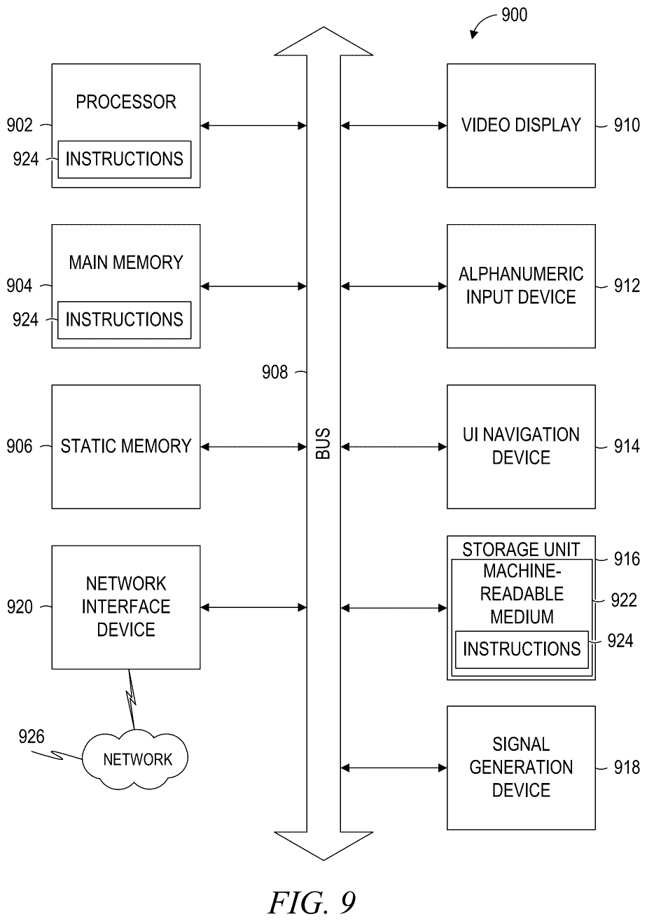

The application servers 130A-130B, the database servers 150A-150B, and the client devices 160A-160B may each be implemented in a computer system, in whole or in part, as described below with respect to FIG. 9. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., two application servers 130A-130B, two client devices 160A and 160B, and the like), any number of each element is contemplated. For example, the application server 130A may be one of dozens or hundreds of active and standby servers and provide services to millions of client devices.

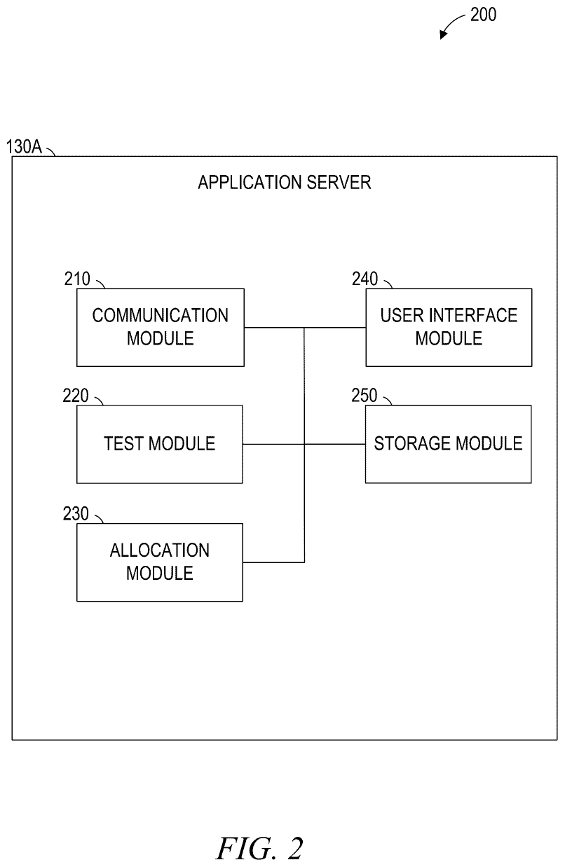

FIG. 2 shows a block diagram 200 of an application server, suitable for allocating resources in a microservice system. The application server 130A is shown as including a communication module 210, a test module 220, an allocation module 230, a user interface module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may send a user interface (e.g., HTML for rendering in a web browser) from the user interface module 240 to the client device 160A. The communication module 210 may receive, from the client device 160A and via the user interface, a request to determine an allocation of resources to microservices.

The test module 220 tests microservice applications. For example, a test suite may be run against a microservice application to determine relative capacity and resource consumption values for the microservices in the microservice application. Based on results generated by the test module 220, the allocation module 230 determines an allocation of resources to the microservices. The user interface module 240 may present the determined allocations, receive modifications to the determined allocations, and receive commands to approve the allocations, either original or modified.

Data, metadata, documents, instructions, or any suitable combination thereof may be stored and accessed by the storage module 250. For example, local storage of the application server 130A, such as a hard drive, may be used. As another example, network storage may be accessed by the storage module 250 via the network 190.

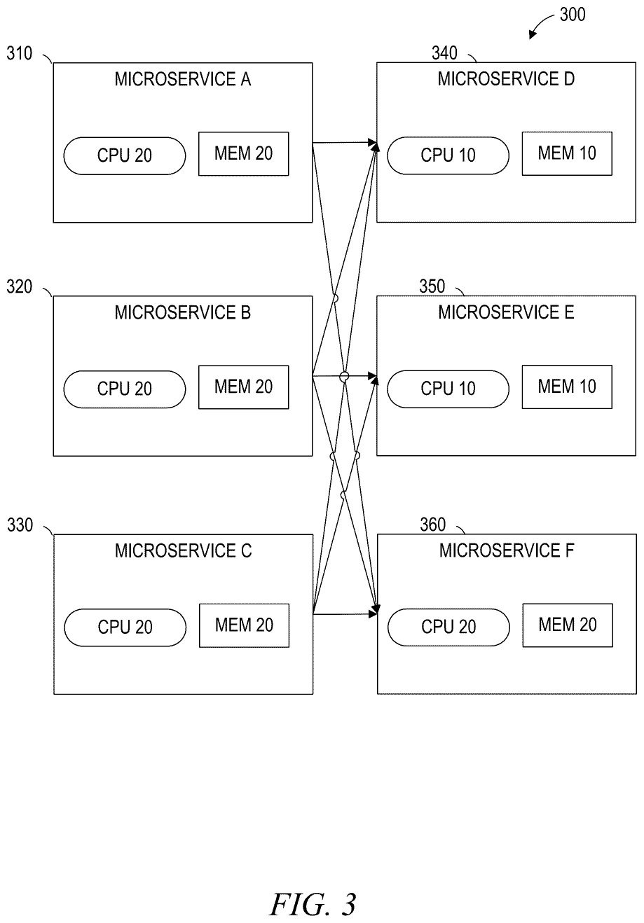

FIG. 3 is a block diagram 300 of an example microservice system comprising six microservices 310, 320, 330, 340, 350, and 360, with an initial allocation of resources. The six microservices 310-360 are connected with arrows that indicate which of the microservices 310-360 make use of other ones of the microservices 310-360. For example, the microservice 310 makes use of the microservices 340 and 360.

As an initial allocation, the microservices 310, 320, 330, and 360 are each allocated 20% of available CPU resources and 20% of available memory resources; the microservices 450 and 350 are each allocated 10% of available CPU resources and 10% of available memory resources. The initial allocation may be determined by an administrator or based on data provided by the microservice developers. Other options include an equal allocation of resources to the microservices and a random distribution of resources to microservices. It should be noted that FIG. 3 is for illustrative purposes. While solid lines are shown around each of the microservices 310-360, in many implementations the various CPUs and memory units will be assigned (e.g., perhaps through an addressing scheme) and thus not permanently allocated to any one microservice 310-360.

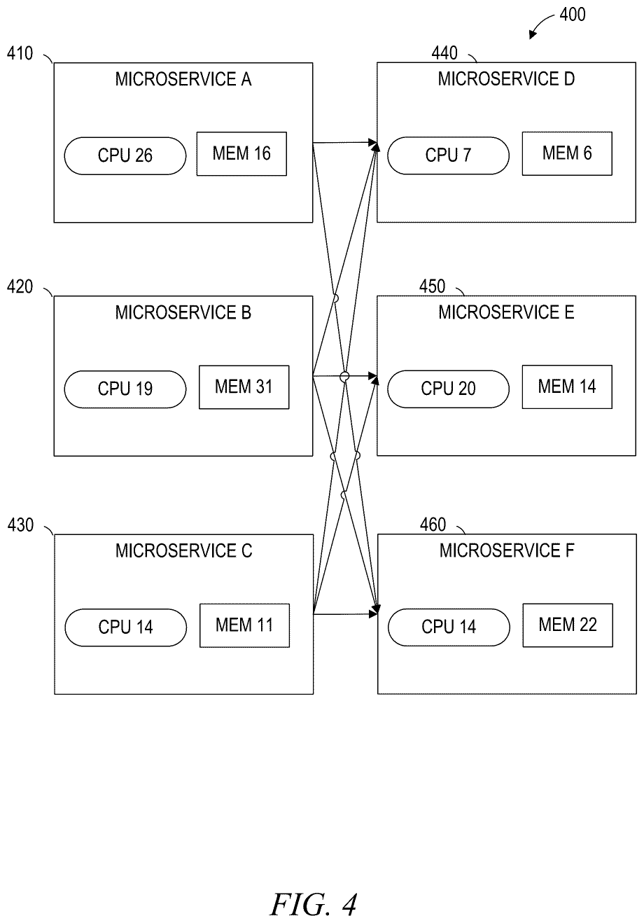

FIG. 4 is a block diagram 400 of the example microservice system of FIG. 3, after allocation of resources. The microservices 410, 420, 430, 440, 450, and 460 correspond to the microservices 310-360 of FIG. 3, but with a different allocation of resources. After allocation of resources, no two of the microservices 410-460 have identical resources allocated. Again, the solid lines around microservices 410-460 are merely for illustrative purposes.

The allocation of resources shown in FIG. 4 may be determined based on measuring actual resource consumption of the microservices 310-360 of FIG. 3 under test conditions, in combination with a planned capacity for the microservices 310-360. In the example of FIG. 4, the CPU allocation to the microservices 410 and 450 has been increased and the CPU allocation to the microservices 420, 430, 440, and 460 has been decreased. Additionally, the memory allocation to the microservices 420, 450, and 460 has been increased and the memory allocation to the microservices 410, 430, and 440 has been decreased.

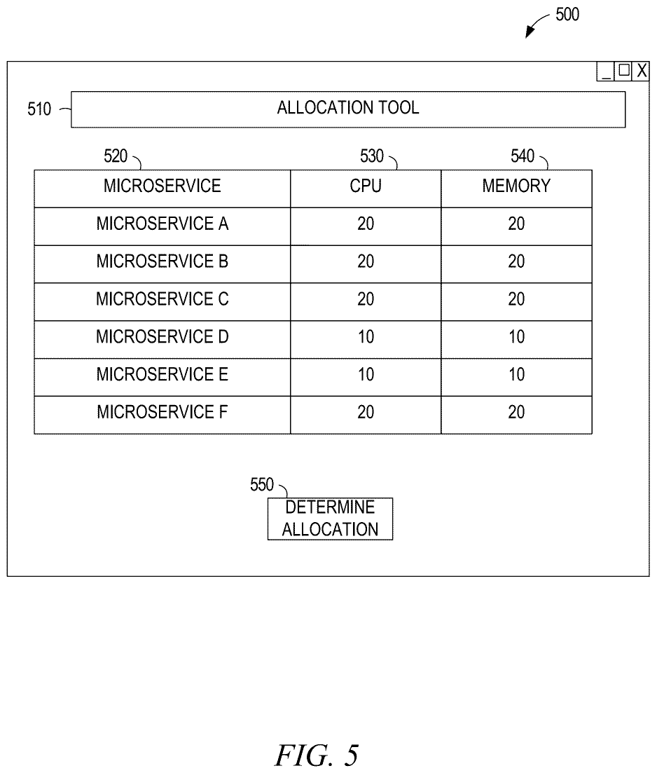

FIG. 5 shows an illustration of an example user interface 500 for allocating resources in a microservice system. The user interface 500 may be generated by the application server 130A and presented on a display device of the client device 160A or 160B, all of FIG. 1. The user interface 500 may be presented to allow a user to provide an initial allocation of resources to microservices for testing. The user interface 500 includes a title 510, columns 520, 530, and 540, and a button 550. A title of the column 520 indicates that the column 520 identifies the microservices for which resources are being allocated. A title of the column 530 indicates that the column 530 identifies a percentage of CPU resources to be allocated to each microservice. A title of the column 540 indicates that the column 540 identifies a percentage of memory resources to be allocated to each microservice.

The user interface 500 may allow a user to select individual cells of the columns 530 and 540 to manipulate the values of the cells. For example, the user may select the cell displaying the CPU resources for “Microservice A” and enter a value of fifteen, reducing the initial CPU resources allocated to that microservice.

The button 550 is operable to begin testing of the microservice application to empirically determine an allocation of resources to the microservices. Thus, by use of the user interface 500, the user is enabled to initiate a process of allocating resources in a microservice system.

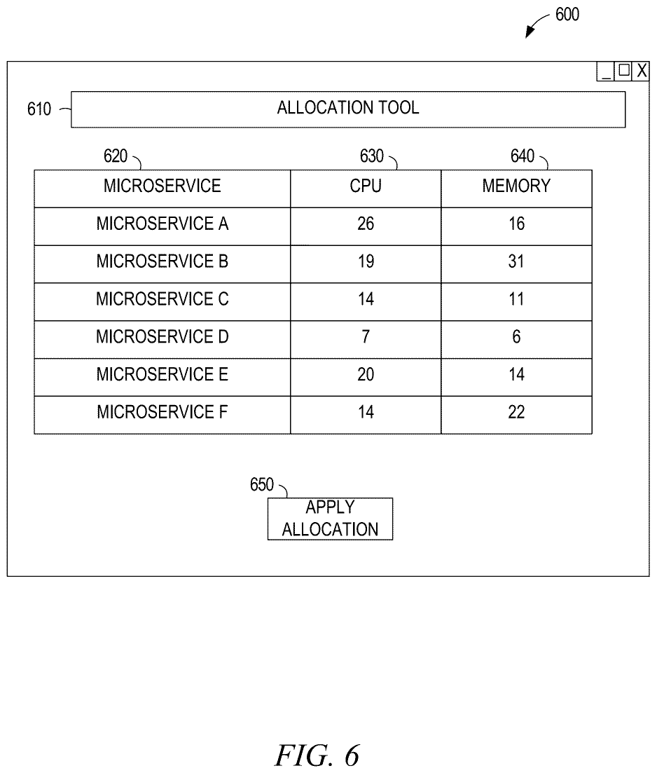

FIG. 6 shows an illustration of an example user interface 600 for allocating resources in a microservice system. The user interface 600 may be displayed after testing has been performed, initiated by detecting a user interaction with the button 550 of FIG. 5. The user interface 600 includes a title 610, columns 620, 630, and 640, and a button 650. The title 610 indicates that the user interface 600 is for an allocation tool. The columns 620-640 correspond to the columns 520-540 of FIG. 5. However, the values for the resource allocations shown in the columns 630 and 640 are the results generated by a resource allocation tool.

As can be seen by comparison of FIGS. 5 and 6, the CPU and memory allocation values for every one of the six microservices has changed. The user interface 600 may allow the user to modify the determined allocation values. For example, the user may increase the CPU allocation of “Microservice D” from 7 to 10 and decrease the CPU allocation of “Microservice A” from 26 to 23. After any user-initiated modifications are made, the button 650 is used to submit the resource allocation values to the application server 120A. In response, the application server 120A deploys the microservice application with the resource allocations, either as generated by the resource allocation tool or as modified by the user.

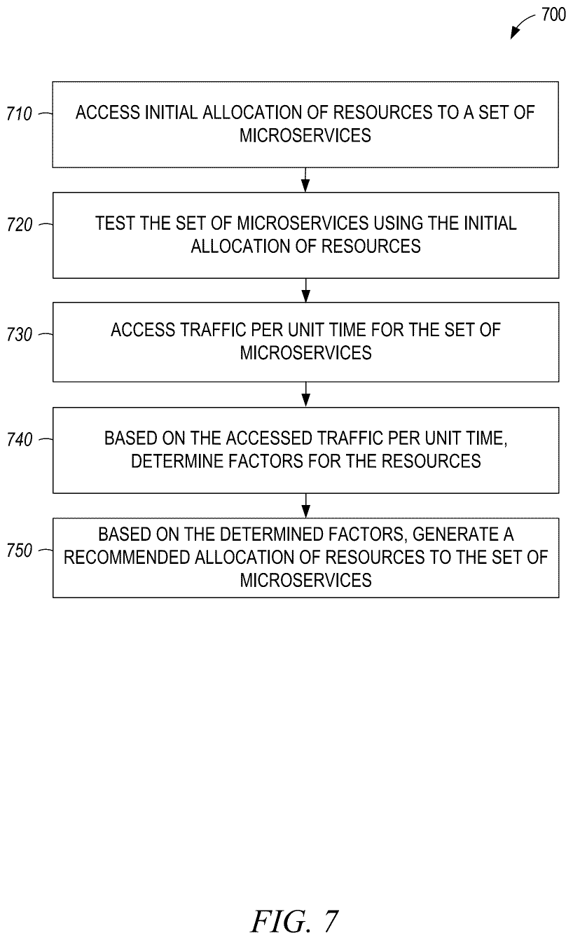

FIG. 7 shows a flowchart illustrating a method 700 of allocating resources in a microservice system. The method 700 includes operations 710, 720, 730, 740, and 750. By way of example and not limitation, the method 700 is described as being performed by the application server 130A of FIG. 1, using the modules of FIG. 2, the microservices of FIGS. 3 and 4, and the user interfaces of FIGS. 5 and 6.

The capacity of a service is approximately linearly related to the resources allocated to it. In other words, if allocated CPU resources are sufficient, the capacity of the service will be approximately linearly related to the memory allocation. If the allocated memory resources are sufficient, the capacity of the service will be approximately linearly related to the CPU allocation. Accordingly, for any service sᵢ, the following two relations hold:

$${cap}_{i} = {a}_{i} \times {cpu}_{i} + {b}_{i} \qquad Equation 1$$

$${cap}_{i} = {c}_{i} \times {mem}_{i} + {d}_{i} \qquad Equation 2$$

In Equation 1, cpuᵢ is the amount of CPU resources allocated to the service sᵢ when there is sufficient memory and capᵢ is the resulting capacity of the service sᵢ. The slope and y-intercept of the linear approximation are determined by the constants aᵢ and bᵢ, which are determined based on the data accessed in operations 710 and 720.

In Equation 2, memᵢ is the amount of memory resources allocated to the service sᵢ when there is sufficient CPU and capᵢ is the resulting capacity of the service sᵢ. The slope and y-intercept of the linear approximation are determined by the constants cᵢ and dᵢ, which are determined based on the data accessed in operations 710 and 720.

A set of M tests may be performed in which sufficient memory is allocated to each microservice, with varying CPU resource allocations. These tests result in M data points for each microservice, with each data point being a pair of the form (cpuᵢ, capᵢ), showing the capacity for microservice i when cpuᵢ CPU resources were allocated to the microservice. As nomenclature, these data points are

$$( {cpu}_{i}^{( 1 )} , {cap}_{i}^{( 1 )} ) , ( {cpu}_{i}^{( 2 )} , {cap}_{i}^{( 2 )} ) , … , ( {cpu}_{i}^{( M )} , {cap}_{i}^{( M )} ) .$$

Using the least squares method, aᵢ and bᵢ can be found using the two equations below.

$${a}_{i} = \frac{M \times {\sum }_{m = 1}^{M} ( {cpu}_{i}^{( m )} \times {cap}_{i}^{( 1 )} ) - {\sum }_{m = 1}^{M} {cpu}_{i}^{( m )} \times {\sum }_{m = 1}^{M} {cap}_{i}^{( m )}}{M \times {\sum }_{m = 1}^{M} {( {cpu}_{i}^{( m )} )}^{2} - {( {\sum }_{m = 1}^{M} {cpu}_{i}^{( m )} )}^{2}} \qquad Equation 3$$

$${b}_{i} = \frac{1}{M} \times {\sum }_{m = 1}^{M} ( {cap}_{i}^{( m )} - {a}_{i} \times {cpu}_{i}^{( m )} ) \qquad Equation 4$$

Similarly, a set of M tests may be performed in which sufficient CPU is allocated to each microservice, with varying memory resource allocations. These tests result in M data points for each microservice, with each data point being a pair of the form (memᵢ, capᵢ), showing the capacity for microservice i when memᵢ memory resources were allocated to the microservice. As nomenclature, these data points are

$$( {mem}_{i}^{( 1 )} , {cap}_{i}^{( 1 )} ) , ( {mem}_{i}^{( 2 )} , {cap}_{i}^{( 2 )} ) , … , ( {mem}_{i}^{( M )} , {cap}_{i}^{( M )} ) .$$

Using the least squares method, cᵢ and dᵢ can be found using the two equations below.

$${c}_{i} = \frac{\begin{matrix}M \times {\sum }_{m = 1}^{M} ( {mem}_{i}^{( m )} \times {cap}_{i}^{( m )} ) - \\ {\sum }_{m = 1}^{M} {mem}_{i}^{( m )} \times {\sum }_{m = 1}^{M} {cap}_{i}^{( m )}\end{matrix}}{M \times {\sum }_{m = 1}^{M} {( {mem}_{i}^{( m )} )}^{2} - {( {\sum }_{m = 1}^{M} {mem}_{i}^{( m )} )}^{2}} \qquad Equation 5$$

$${d}_{i} = \frac{1}{M} \times {\sum }_{m = 1}^{M} ( {cap}_{i}^{( m )} - {c}_{i} \times {mem}_{i}^{( m )} ) \qquad Equation 6$$

After solving for aᵢ, bᵢ, cᵢ, and dᵢ, Equations 1 and 2 can be solved to determine the allocation of CPU and memory resources based on the capacity of the microservice.

$${cpu}_{i} = \frac{{cap}_{i} - {b}_{i}}{{a}_{i}} \qquad Equation 7$$

$${mem}_{i} = \frac{{cap}_{i} - {d}_{i}}{{c}_{i}} \qquad Equation 8$$

The tests used to generate data to determine aᵢ, bᵢ, cᵢ, and dᵢ may be performed separately for each microservice before the method 700 is begun.

In operation 710, the allocation module 230 accesses an initial allocation of resources to a set of microservices. For example, the initial allocation of resources to the set of microservices shown in FIG. 3 may be accessed from a database table.

The testing module 220 tests the microservices using the initial allocation of resources, simulating a production environment (operation 720). In operation 730, the allocation module 230 accesses a traffic per unit of time for each microservice in the set of resources. The tests may be performed multiple times using different scenarios, and the accessed traffic per unit of time (e.g., calls per second) may be determined by averaging the results of the multiple tests.

Consider an example with N microservices, {s₁, s₂, . . . , s_{N}}. The traffic per unit time for each microservice, accessed in operation 720, is {tf₁, tf₂, . . . , tf_{N}}. The traffic capacity in the production environment is {prodCap₁, prodCap₂, . . . , prodCap_{N}}. The ratio of the production capacity to the measured traffic, k, is the same for all microservices.

The allocation module 230, in operation 730, determines factors for the resources based on the accessed traffic per unit time. Thus, in this example, a factor for CPU and a factor for memory is determined.

Considering the total amount of CPU resources being allocated to the microservice application as CPUₜₒₜₐₗ and the total amount of memory resources being allocated to the microservice application as MEMₜₒₜₐₗ, the equations below result.

$${CPU}_{total} = {\sum }_{i = 1}^{N} {cpu}_{i} = {\sum }_{i = 1}^{N} \frac{{cap}_{i} - {b}_{i}}{{a}_{i}} \qquad Equation 9$$

$${MEM}_{total} = {\sum }_{i = 1}^{N} {mem}_{i} = {\sum }_{i = 1}^{N} \frac{{cap}_{i} - {d}_{i}}{{c}_{i}} \qquad Equation 10$$

Since the production capacity is a multiple of the traffic in the test environment, equations 9 and 10 can be rewritten as follows.

$${CPU}_{total} = {\sum }_{i = 1}^{N} {cpu}_{i} = {\sum }_{i = 1}^{N} \frac{k \times {tf}_{i} - {b}_{i}}{{a}_{i}} = k \times {\sum }_{i = 1}^{N} \frac{{tf}_{i}}{{a}_{i}} - {\sum }_{i = 1}^{N} \frac{{b}_{i}}{{a}_{i}} \qquad Equation 11$$

$${MEM}_{total} = {\sum }_{i = 1}^{N} {mem}_{i} = {\sum }_{i = 1}^{N} \frac{k \times {tf}_{i} - {d}_{i}}{{c}_{i}} = k \times {\sum }_{i = 1}^{N} \frac{{tf}_{i}}{{c}_{i}} - {\sum }_{i = 1}^{N} \frac{{d}_{i}}{{c}_{i}} \qquad Equation 12$$

In operation 740, the allocation module 230 determines, based on the accessed traffic per unit time, factors for the resources. For example, using the values related to the CPU measurements, k may be determined using the equation below.

$${k}_{cpu} = \frac{{CPU}_{total} + {\sum }_{i = 1}^{N} \frac{{b}_{i}}{{a}_{i}}}{{\sum }_{i = 1}^{N} \frac{{tf}_{i}}{{a}_{i}}} \qquad Equation 13$$

Similarly, k may be determined using the memory measurements using Equation 14.

$${k}_{mem} = \frac{{MEM}_{total} + {\sum }_{i = 1}^{N} \frac{{d}_{i}}{{c}_{i}}}{{\sum }_{i = 1}^{N} \frac{{tf}_{i}}{{c}_{i}}} \qquad Equation 14$$

The two solutions for k, the factors for the CPU and memory resources, should be within a predetermined threshold (e.g., 10%) of each other. If they are not, the test system may be modified and further testing performed to resolve the discrepancy. Otherwise, in operation 750, the allocation module generates a recommended allocation of resources to the set of microservices based on the determined factors. For example, the CPU and memory resources recommended for allocation to each service may be determined by Equations 15 and 16.

$${cpu}_{i} = \frac{{k}_{cpu} \times {tf}_{i} - {b}_{i}}{{a}_{i}} \qquad Equation 15$$

$${mem}_{i} = \frac{{k}_{mem} \times {tf}_{i} - {d}_{i}}{{c}_{i}} \qquad Equation 16$$

As a specific example, consider the initial allocation of resources shown in FIGS. 3 and 5. In this example, the measured traffic per unit time for the six services is shown in the table below.

| Service | Traffic per unit time |
|---|---|
| s₁ | tf₁ = 2500 |
| s₂ | tf₂ = 3500 |
| s₃ | tf₃ = 2000 |
| s₄ | tf₄ = 1550 |
| s₅ | tf₅ = 2550 |
| s₆ | tf₆ = 2350 |

Using the allocated resource values from FIGS. 3 and 5, and the tfᵢ values as the capᵢ values, the a, b, c, and d factors for each service can be determined using Equations 3-6. The results are shown in the table below.

| | |
|---|---|
| Service | Factors |

| | | | | |
|---|---|---|---|---|
| s₁ | a₁ = 3315, | b₁ = −253, | c₁ = 5212, | d₁ = −145 |
| s₂ | a₂ = 6642, | b₂ = −457, | c₂ = 3901, | d₂ = −192 |
| s₃ | a₃ = 4893, | b₃ = −332, | c₃ = 6394, | d₃ = −287 |
| s₄ | a₄ = 8136, | b₄ = −648, | c₄ = 8617, | d₄ = −561 |
| s₅ | a₅ = 4571, | b₅ = −373, | c₅ = 6256, | d₅ = −277 |
| s₆ | a₆ = 5729, | b₆ = −224, | c₆ = 3694, | d₆ = −372 |

Plugging these values into Equations 13 and 14 gives a value of 35.0 for k_{cpu} and 34.3 for kₘₑₘ. These two values for k are reasonably close to each other (e.g., within a predetermined threshold of 10%), and so may be used for resource allocation. Applying Equations 15 and 16 gives the resource allocation results shown in FIGS. 4 and 6.

In some example embodiments, the recommended allocation is automatically used and the microservice application is deployed without further human involvement. In other example embodiments, an administrator reviews the recommended allocation and accepts or modifies the allocation of resources before the microservices are deployed.

By way of example and not limitation, the discussion above refers to CPU processing resources. In various example embodiments, other processing resources may be used, such as graphics processing units (GPUs), remote processing units, quantum processing units, or any suitable combination thereof.

In view of the above-described implementations of subject matter, this application discloses the following list of examples, wherein one feature of an example in isolation or more than one feature of an example, taken in combination and, optionally, in combination with one or more features of one or more further examples are also examples falling within the disclosure of this application.

Example 1 is a system comprising: one or more hardware processors; and a memory that stores instructions that, when executed by the one or more hardware processors, cause the one or more hardware processors to perform operations comprising: testing a plurality of microservices in a test system using an initial allocation of processing resources; based on a traffic per unit time for each of the plurality of microservices, determining a factor for the processing resources; based on the determined factor, generating a recommended allocation of the processing resources to the plurality of microservices; and allocating resources in a production system according to the recommended allocation of the processing resources.

In Example 2, the subject matter of Example 1, wherein the operations further comprise: causing presentation of a user interface that includes the recommended allocation of the processing resources to a first microservice of the plurality of microservices; receiving, via the user interface, a modified allocation of the processing resources to the first microservice; and allocating resources to the first microservice according to the modified allocation of the processing resources.

In Example 3, the subject matter of Examples 1-2, wherein the testing of the plurality of microservices in the test system comprises performing several tests with different scenarios and averaging results of the several tests.

In Example 4, the subject matter of Examples 1-3, wherein the operations further comprise: based on the traffic per unit time for each of the plurality of microservices, determining a second factor for memory resources; and based on the determined second factor, generating a recommended allocation of the memory resources to the plurality of microservices; wherein the allocating of the resources in the production system is further according to the recommended allocation of the memory resources.

In Example 5, the subject matter of Example 4, wherein the operations further comprise: determining, based on an amount of a difference between the factor for the processing resources and the second factor for the memory resources, to modify the test system and repeat the testing of the plurality of microservices.

In Example 6, the subject matter of Examples 4-5, wherein the determining of the second factor for the memory resources comprises determining linear approximation of capacity as a function of allocated memory resources for each of the plurality of microservices.

In Example 7, the subject matter of Examples 1-6, wherein the determining of the factor for the processing resources comprises determining linear approximation of capacity as a function of allocated processing resources for each of the plurality of microservices.

Example 8 is a non-transitory computer-readable medium that stores instructions that, when executed by one or more processors, cause the one or more processors to perform operations comprising: testing a plurality of microservices in a test system using an initial allocation of processing resources; based on a traffic per unit time for each of the plurality of microservices, determining a factor for the processing resources; based on the determined factor, generating a recommended allocation of the processing resources to the plurality of microservices; and allocating resources in a production system according to the recommended allocation of the processing resources.

In Example 9, the subject matter of Example 8, wherein the operations further comprise: causing presentation of a user interface that includes the recommended allocation of the processing resources to a first microservice of the plurality of microservices; receiving, via the user interface, a modified allocation of the processing resources to the first microservice; and allocating resources to the first microservice according to the modified allocation of the processing resources.

In Example 10, the subject matter of Examples 8-9, wherein the testing of the plurality of microservices in the test system comprises performing several tests with different scenarios and averaging results of the several tests.

In Example 11, the subject matter of Examples 8-10, wherein the operations further comprise: based on the traffic per unit time for each of the plurality of microservices, determining a second factor for memory resources; and based on the determined second factor, generating a recommended allocation of the memory resources to the plurality of microservices; wherein the allocating of the resources in the production system is further according to the recommended allocation of the memory resources.

In Example 12, the subject matter of Example 11, wherein the operations further comprise: determining, based on an amount of a difference between the factor for the processing resources and the second factor for the memory resources, to modify the test system and repeat the testing of the plurality of microservices.

In Example 13, the subject matter of Example 12, wherein the determining of the second factor for the memory resources comprises determining linear approximation of capacity as a function of allocated memory resources for each of the plurality of microservices.

In Example 14, the subject matter of Examples 8-13, wherein the determining of the factor for the processing resources comprises determining linear approximation of capacity as a function of allocated processing resources for each of the plurality of microservices.

Example 15 is a method comprising: testing, by one or more hardware processors, a plurality of microservices in a test system using an initial allocation of processing resources; based on a traffic per unit time for each of the plurality of microservices, determining a factor for the processing resources; based on the determined factor, generating a recommended allocation of the processing resources to the plurality of microservices; and allocating resources in a production system according to the recommended allocation of the processing resources.

In Example 16, the subject matter of Example 15 includes causing presentation of a user interface that includes the recommended allocation of the processing resources to a first microservice of the plurality of microservices; receiving, via the user interface, a modified allocation of the processing resources to the first microservice; and allocating resources to the first microservice according to the modified allocation of the processing resources.

In Example 17, the subject matter of Examples 15-16, wherein the testing of the plurality of microservices in the test system comprises performing several tests with different scenarios and averaging results of the several tests.

In Example 18, the subject matter of Examples 15-17 includes, based on the traffic per unit time for each of the plurality of microservices, determining a second factor for memory resources; and based on the determined second factor, generating a recommended allocation of the memory resources to the plurality of microservices; wherein the allocating of the resources in the production system is further according to the recommended allocation of the memory resources.

In Example 19, the subject matter of Example 18 includes determining, based on an amount of a difference between the factor for the processing resources and the second factor for the memory resources, to modify the test system and repeat the testing of the plurality of microservices.

In Example 20, the subject matter of Examples 15-19, wherein the determining of the factor for the processing resources comprises determining linear approximation of capacity as a function of allocated processing resources for each of the plurality of microservices.

Example 21 is an apparatus comprising means to implement any of Examples 1-20.

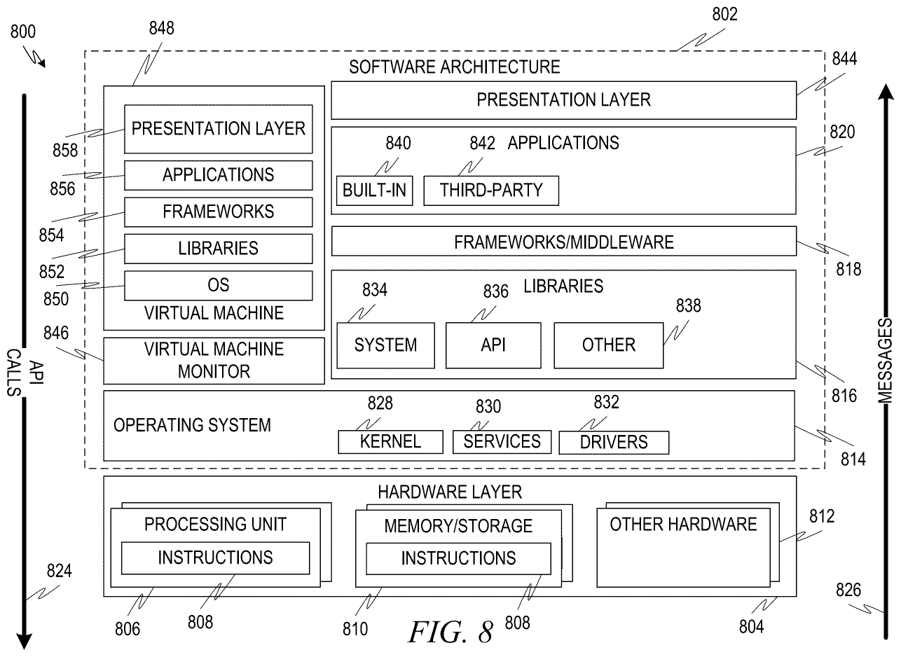

FIG. 8 shows a block diagram 800 showing one example of a software architecture 802 for a computing device. The software architecture 802 may be used in conjunction with various hardware architectures, for example, as described herein. FIG. 8 is merely a non-limiting example of a software architecture, and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and presentation layer 844. Operationally, the applications 820 and/or other components within the layers may invoke API calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphical user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built-in operating system functions (e.g., kernel 828, services 830 and/or drivers 832), libraries (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856 and/or presentation layer 858. These layers of software architecture executing within the virtual machine 848 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 9 shows a block diagram of a machine in the example form of a computer system 900 within which instructions 924 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a CPU, a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube [CRT]). The computer system 900 also includes an alphanumeric input device 912 (e.g., a keyboard or a touch-sensitive display screen), a user interface navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting a machine-readable medium 922.

While the machine-readable medium 922 is shown in FIG. 9 to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with the instructions 924. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
one or more hardware processors; and
a memory that stores instructions that, when executed by the one or more hardware processors, cause the one or more hardware processors to perform operations comprising:
testing a plurality of microservices in a test system using an initial allocation of processing resources;
based on a traffic per unit time for each of the plurality of microservices, determining a factor for the CPU resources;
based on the determined factor, generating a recommended allocation of the processing resources to the plurality of microservices; and
allocating resources in a production system according to the recommended allocation of the processing resources.

2. The system of claim 1, wherein the operations further comprise:
causing presentation of a user interface that includes the recommended allocation of the processing resources to a first microservice of the plurality of microservices;
receiving, via the user interface, a modified allocation of the processing resources to the first microservice; and
allocating resources to the first microservice according to the modified allocation of the processing resources.

3. The system of claim 1, wherein the testing of the plurality of microservices in the test system comprises performing several tests with different scenarios and averaging results of the several tests.

4. The system of claim 1, wherein the operations further comprise:
based on the traffic per unit time for each of the plurality of microservices, determining a second factor for memory resources; and
based on the determined second factor, generating a recommended allocation of the memory resources to the plurality of microservices;
wherein the allocating of the resources in the production system is further according to the recommended allocation of the memory resources.

5. The system of claim 4, wherein the operations further comprise:
determining, based on an amount of a difference between the factor for the processing resources and the second factor for the memory resources, to modify the test system and repeat the testing of the plurality of microservices.

6. The system of claim 4, wherein the determining of the second factor for the memory resources comprises determining linear approximation of capacity as a function of allocated memory resources for each of the plurality of microservices.

7. The system of claim 1, wherein the determining of the factor for the processing resources comprises determining linear approximation of capacity as a function of allocated processing resources for each of the plurality of microservices.

8. A non-transitory computer-readable medium that stores instructions that, when executed by one or more processors, cause the one or more processors to perform operations comprising:
testing a plurality of microservices in a test system using an initial allocation of processing resources;
based on a traffic per unit time for each of the plurality of microservices, determining a factor for the processing resources;
based on the determined factor, generating a recommended allocation of the processing resources to the plurality of microservices; and
allocating resources in a production system according to the recommended allocation of the processing resources.

9. The non-transitory computer-readable medium of claim 8, wherein the operations further comprise:
causing presentation of a user interface that includes the recommended allocation of the processing resources to a first microservice of the plurality of microservices;
receiving, via the user interface, a modified allocation of the CPU resources to the first microservice; and
allocating resources to the first microservice according to the modified allocation of the processing resources.

10. The non-transitory computer-readable medium of claim 8, wherein the testing of the plurality of microservices in the test system comprises performing several tests with different scenarios and averaging results of the several tests.

11. The non-transitory computer-readable medium of claim 8, wherein the operations further comprise:
based on the traffic per unit time for each of the plurality of microservices, determining a second factor for memory resources; and
based on the determined second factor, generating a recommended allocation of the memory resources to the plurality of microservices;
wherein the allocating of the resources in the production system is further according to the recommended allocation of the memory resources.

12. The non-transitory computer-readable medium of claim 11, wherein the operations further comprise:
determining, based on an amount of a difference between the factor for the processing resources and the second factor for the memory resources, to modify the test system and repeat the testing of the plurality of microservices.

13. The non-transitory computer-readable medium of claim 12, wherein the determining of the second factor for the memory resources comprises determining linear approximation of capacity as a function of allocated memory resources for each of the plurality of microservices.

14. The non-transitory computer-readable medium of claim 8, wherein the determining of the factor for the processing resources comprises determining linear approximation of capacity as a function of allocated processing resources for each of the plurality of microservices.

15. A method comprising:
testing, by one or more hardware processors, a plurality of microservices in a test system using an initial allocation of processing resources;
based on a traffic per unit time for each of the plurality of microservices, determining a factor for the processing resources;
based on the determined factor, generating a recommended allocation of the processing resources to the plurality of microservices; and
allocating resources in a production system according to the recommended allocation of the processing resources.

16. The method of claim 15, further comprising:
causing presentation of a user interface that includes the recommended allocation of the processing resources to a first microservice of the plurality of microservices;
receiving, via the user interface, a modified allocation of the processing resources to the first microservice; and
allocating resources to the first microservice according to the modified allocation of the processing resources.

17. The method of claim 15, wherein the testing of the plurality of microservices in the test system comprises performing several tests with different scenarios and averaging results of the several tests.

18. The method of claim 15, further comprising:
based on the traffic per unit time for each of the plurality of microservices, determining a second factor for memory resources; and
based on the determined second factor, generating a recommended allocation of the memory resources to the plurality of microservices;
wherein the allocating of the resources in the production system is further according to the recommended allocation of the memory resources.

19. The method of claim 18, further comprising:
determining, based on an amount of a difference between the factor for the processing resources and the second factor for the memory resources, to modify the test system and repeat the testing of the plurality of microservices.

20. The method of claim 15, wherein the determining of the factor for the processing resources comprises determining linear approximation of capacity as a function of allocated processing resources for each of the plurality of microservices.
